(19) United States
(12) Patent Application Publication
(10) Pub. No.: US 2003/0224138 A1
(43) Pub. Date: Dec. 4, 2003

(54) Pile-forming assembly comprising a pile and a device for fixing the pile by means of a hook and loop system

(75) Inventor: Pavel Hammer, Mossingen/ Oschingen (DE)

Correspondence Address: Edward G. Greive, Rener, Kenner, Greive, Bobak, Taylor & Weber, Fourth Floor, First National Tower, Akron, OH, 44308-1456, US

(73) Assignee: APLIX

(21) Appl. No.: 10/448,599

(22) Filed: May 30, 2003

(30) Foreign Application Priority Data
May 31, 2002 (DE) 0206707

(51) Int. Cl. B32B 3/02; B32B 33/00; B32B 3/06

(52) U.S. Cl. 428/95; 428/99; 428/100

(57) ABSTRACT

A device for fixing a pile to the ground, the device comprising a plastic sheet (1) having an upper surface from which hooks (5) project and are adapted to co-operate with loops on an under-surface of the pile in order to fix the pile to the ground, a nonwoven sheet (3) being fixed to the under-surface of the plastic sheet (1).

The invention relates to an assembly comprising a pile or carpet and a device for fixing the pile or carpet to a floor.

“Pile” or “carpet” means a functional and ornamental floor covering, inter alia in the form of a fabric stretched flat over a horizontal surface such as the floor. The carpet or pile can be made by hand or machine, inter alia velvet carpets or piles, woven Wilton carpets, double-length, Axminster, chenille carpets or non-woven tufted, embroidered, knitted, bonded, flocked, mechanically lock-stitched carpets or velvet-free carpets or piles similar in appearance to a very large cloth. Usually a pile is fixed to the entire surface of the floor of a room bounded by the walls thereof.

A first existing system for fixing a pile or a carpet to the floor simply consists of a layer of adhesive at the interface between the floor and the pile. This system has the disadvantage, on the one hand, that the pile is difficult to remove when it needs to be changed, since the floor takes a long time to clean. Once the pile has been positioned and the adhesive has dried, it cannot be moved if for example it has not been positioned exactly as desired.

One idea for obviating this disadvantage has been to construct gripping surfaces consisting of a plastic sheet with projecting hooks (“hook” in the present application means any kind of attaching device such as a hook, harpoon or mushroom capable of engaging in loops so as to be fixed therein). The hooks, in co-operation with a knitted loop or a, layer of looped knitted fibres covering the back of the pile, hold the pile while enabling changes to be made easily in either the pile or the position thereof. The gripping surfaces comprising a sheet usually have a self-adhesive layer on the back, protected by paper which is pulled off before sticking the back of the gripping surface to the floor. In other cases the gripping surface is directly stuck to the floor via the side without hooks.

This system effectively solves the problem of an irreversibly laid pile but has a number of disadvantages. Firstly in order to use a self-adhesive coating, the floor has to be very clean and completely free from dust, which is often difficult to achieve under the conditions on a building site. Usually also, the plastic sheet, frequently based on polypropylene, is difficult to stick directly to the floor, so that very expensive adhesives need to be used.

Finally, the gripping plastic sheet or surface and the hooks projecting therefrom form a rigid assembly, inter alia when in the form of a strip from 30 to 50 cm and sometimes up to 1 metre wide, so that it cannot closely follow irregularities in the floor and it is more difficult to stick the self-adhesive surfaces to the ground and fix the under-surface of the looped pile to the intermediate self-adhesive sheet at irregular places such as slight peaks or hollows in the floor.

The invention aims to obviate these disadvantages by means of a pile assembly comprising a pile and a device for fixing the pile to the floor, the device comprising a plastic sheet from which hooks project. The sheet is easier to stick to the floor and inter alia requires a less clean floor and less expensive adhesives than in the case of the prior-art assemblies. The invention also yields a pile-forming assembly comprising a device which fixes the pile to the floor and, when laid, is more capable of absorbing rough parts or irregularities in the floor and following its shape.

The invention relates to a pile assembly comprising a pile and a device for fixing the pile to the floor, the device consisting of a sheet of plastic with an upper surface with projecting hooks for co-operating with loops extending from the under-surface of the pile so as to fix the pile to the floor, characterised in that a nonwoven sheet is fixed to the under-surface of the plastic sheet, and the hooks project by between 0.2 and 3 mm, preferably between 0.35 and 0.9 mm from the upper surface of the base of the sheet.

The nonwoven sheet can thus be stuck easily to the floor, using commercial low-cost adhesives as used at present in the trade when the pile is stuck to the floor directly. The nonwoven is relatively thick and can absorb rough places and is relatively extensible so as to compensate irregularities in the floor and reduce the number of cavities formed between the floor and the pile, compared with conventional systems.

Preferably, the nonwoven sheet has a thickness between 10 g/m² and 150 g/m², preferably between 30 g/m² and 80 g/m².

This weight range is a good compromise between the contour-absorbing capacity and the amount of nonwoven used for making the fixing device.

In a preferred embodiment of the invention, the nonwoven is made of polyester, polypropylene, polyamide, natural fibres or mixtures thereof.

According to an improvement of the invention, the plastic sheet is made up of plastic strips with components forming a hook and fixed to the upper surface of the nonwoven, the strips being spaced apart and the gaps between them extending in the longitudinal or machine direction of the nonwoven sheet.

By providing a hooked plastic sheet in the form of a number of spaced-apart strips instead of in one piece, the pile is fixed above it even more efficiently, since the gaps give flexibility to the hooked plastic sheet and help it to follow the various rough places, hollows and troughs formed in the floor and not completely “absorbed” by the nonwoven sheet.

Preferably, the nonwoven sheet has a thickness between 30 and 1.50 m, preferably between 50 cm and 1 m.

Preferably, the strips have a width between 0.5 and 5 cm.

Preferably, the gaps have a width between 0.5 and 5 mm, preferably between 1 and 3 mm.

In a preferred embodiment, a looped knitted or nonwoven fabric is fixed, inter alia stuck, to the back of the pile.

The following by way of example is a description of an embodiment of the invention with reference to the single drawing, which is a representation, not to scale, of a gripping surface according to the invention.

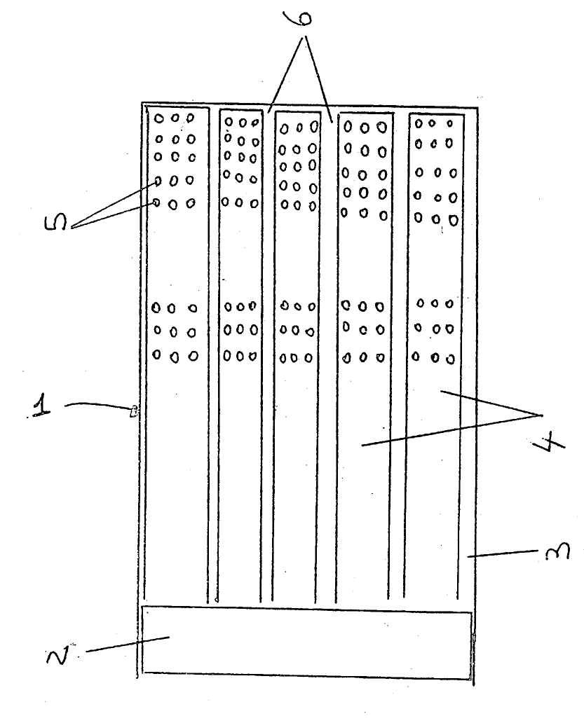

In FIG. 1, a gripping surface 1 is unrolled from a reel 2. It comprises a nonwoven underlying sheet 3 having a thickness of 40 g/m². The under-surface of the nonwoven sheet is for sticking to the floor, using an inexpensive conventional adhesive. Strips 4 each with hooks 5 are secured by sticking, welding or any other suitable method to the upper surface of the nonwoven sheet. The hooks 5 extend directly from the strips 4 and can be formed inter alia by the conventional method of forming hooked strips described in French patent application No: 9 904 331 published on Oct. 13, 2000 in the name of the Applicants and conventionally called the “lamelle” (strip) process. An alternative process is of course the Velcro roll process. The strips 4 are spaced apart by gaps 6 in the longitudinal or machine direction of the nonwoven.

The gaps 6 have a width of 2 mm. The width of the strips is 3 cm.

The height of the hooks, starting from the top surface of a base, is between 0.2 mm and 3 mm, preferably between 0.35 and 0.9 mm. The thickness of the base in the vertical direction of the hooks is between 0.05 and 0.4 mm, preferably between 0.08 and 0.2 mm. The hooks are spaced apart at a density between 80 and 280 cm². The hooks are distributed in uniform, regular manner over the strips.

The gripping surface 1 is used as follows. After the floor has been cleaned, quickly but not necessarily as carefully as in the case of the prior-art devices, the gripping surface 1 is laid on the floor and stuck with a conventional commercially available glue, e.g. acrylic or aqueous dispersion adhesives such as those marked Parfax, Bosklik, Sader, Uzin or Peco and conventionally used for sticking the pile directly to the ground. Once the gripping surface 1 has been stuck to the floor via the nonwoven sheet, the pile is laid. On its under-surface or back, the pile comprises conventional fabric (inter alia looped knitted or looped nonwoven) laid by sticking, coating, welding or the like. These looped fabrics are conventional in the self-adhesive sector. The fabric can inter alia be of knitted or nonwoven polypropylene, polyamide, polyester or other polyolefins, or based on natural fibres such as wool, cisal, coconut, jute, felt or mixtures thereof. The pile is then placed on the floor, when it closely follows the various rough parts of the floor such as troughs or hollows, owing to the relative flexibility of the nonwoven sheet and also owing to the flexibility of the hooked strips due to the gaps between them.

1. A pile assembly comprising a pile and a device for fixing the pile to the floor, the device consisting of a sheet (1) of plastic with an upper surface with projecting hooks (5) for co-operating with loops extending from the under-surface of the pile so as to fix the pile to the floor, characterised in that a nonwoven sheet (3) is fixed to the under-surface of the plastic sheet (1), and the hooks project by between 0.2 and 3 mm, preferably between 0.35 and 0.9 mm from the upper surface of the base of the sheet.

2. An assembly according to claim 1, characterised in that the nonwoven sheet (3) has a thickness between 10 g/m² and 150 g/m², preferably between 30 g/m² and 80 g/m².

3. An assembly according to claim 1, characterised in that the nonwoven is made of polyester, polypropylene, polyamide or natural fibre.

4. An assembly according to claim 1, characterised in that the nonwoven sheet has a thickness between 30 cm and 1.5 m, preferably between 50 cm and 1 m.

5. An assembly according to claim 1, characterised in that the plastic sheet is made up of plastic strips (4) with components (5) forming a hook and fixed to the upper surface of the nonwoven, the strips being spaced apart and the gaps between them extending in the longitudinal or machine direction of the nonwoven sheet.

6. An assembly according claim 1, characterised in that the plastic sheet is of PP (polypropylene), PE (polyethylene), LDPE (low-density polyethylene), HDPE (high-density polyethylene), PA (polyamide), PET (polyester) or mixtures thereof and has a thickness between 0.3 and 0.8 mm.

7. An assembly according to claim 5, characterised in that the strips have a width between 0.5 and 5 cm.

8. An assembly according to claim 5, characterised in that the gaps have a width between 0.5 and 5 mm, preferably between 1 and 3 mm.

9. An assembly according to claim 1, characterised in that the thickness of the base in the vertical direction of the hooks is between 0.05 and 0.4 mm, preferably between 0.08 and 0.2 mm.

10. An assembly according to claim 1, characterised in that a looped or nonwoven knitted fabric is fixed to the back of the pile to form the loops for cooperating with the hooks.
